(19) United States
(12) Patent Application Publication
(10) Pub. No.: US 2009/0097643 A1
(43) Pub. Date: Apr. 16, 2009

(54) Security and transcoding system for transfer of content to portable devices

(76) Inventors: Kumar Ramaswamy, Princeton, NJ (US); Douglas Edward Lankford, Carmel, IN (US)

Correspondence Address: Robert D. Shedd;Thomson Licensing LLC, PO Box 5312, PRINCETON, NJ, 08543-5312, US

(21) Appl. No.: 11/920,037

(22) PCT Filed: May 11, 2006
(86) PCT No.: PCT/US2006/018160

§ 371 Date: Nov. 7, 2007

Related U.S. Application Data
(60) Provisional application No. 60/680,697, filed on May 13, 2005.

(51) Int. Cl. H04N 7/167

(52) U.S. Cl. 380/200

(57) ABSTRACT

A system for passing content data from a subscription service to a portable media device is provided. The system has a set-top box for receiving the content data from the subscription service. A data storage device is operatively connected with the set-top box. A preprocessor is operatively connected to the data storage device. It applies encryption to the content data and has an output to the portable media device.

### RELATED APPLICATION DATA

This application claims the benefit of earlier filed provisional application Ser. No. 60/680,697 filed May 13, 2005 under 35 USC §119.

### FIELD OF THE INVENTION

The present invention relates to the field of digital audio and video player devices and more particularly to a portable media player and subscription service system.

### BACKGROUND OF THE INVENTION

The development of compressed digital audio and video formats, such as the Motion Picture Experts Group-Layer 3 (MP3) and (MPEG) have caused the growth in popularity of recording, storing, transferring, and playing back digital audio and video data on computers and portable media player (PMP) devices. In particular, compressed digital audio and video formats enable more efficient storage and transmission of high-quality audio and video content by reducing the amount of digital data that needs to be stored and transmitted, resulting in data files that could be a fraction of the original uncompressed digital file without unacceptably degrading the quality of the output. PMP devices having the capability to download content from a computer or other broadband access devices (hereinafter simply referred to as a “host”), usually connected to the Internet, have been gaining popularity in the marketplace.

Recently, relatively low-cost, lightweight, compact, PMP's have been developed. These portable devices enable consumers to transfer compressed digital audio and/or video files stored on their hosts/computers to the portable devices through the use of associated computer-based software via an external connection, such as a USB, “FireWire” cable or wireless local area networks(WLANs), and to play the corresponding media on-demand through their PMPs. Users most commonly access the audio on the device by connecting headphones via a standard jack on the device, although it is also possible to connect a line-out cable to other audio output or recording devices, such as a microphone input of a standard home stereo system.

In general, conventional PMPs are capable of allowing their users to (1) transfer compressed media files from a host to the PMPs through the use of associated transfer management software installed on the host and a physical connection to the host, such as a USB cable or other means; (2) store such compressed media files in memory; (3) decode for playback any of a variety of compression algorithms; (4) convert a compressed or uncompressed digital file to an analog format, potentially also processing the signal to enhance the resulting sound and images; (5) process and amplify the resulting analog signal; and (6) produce high-fidelity sound and video for the user, which may be played, paused, fast-forwarded, rewound, skipped or replayed instantly and on-demand.

Programmed entertainment is currently available to consumers through traditional broadcast media and through other means that generally require the use of a device connected to a wired input, such as Internet-based streaming, accessible through laptop and desktop computers and digital cable television and radio services, accessible through cable-connected television sets. Also, subscription-based commercial satellite broadcast services such as DirecTV, cable, DSL or other broadband wireless distribution services for television enable consumers to receive hours of programming by selecting among available stations.

Although programmed entertainment content is often accessed by PMP's through Internet-based streaming, it is desirable to develop enhanced systems and methods for accessing such content from subscription-based commercial broadcast services while protecting the media content from unauthorized copying and/or further distribution from the PMP.

### SUMMARY

Addressing the abovementioned needs, among others, a system for passing content data from a subscription service to a portable media device is provided. The system has a set-top box for receiving the content data from the subscription service. A data storage device is operatively connected with the set-top box. A preprocessor is operatively connected to the data storage device, applies encryption to the content data and has an output to the portable media device.

### BRIEF DESCRIPTION OF THE DRAWINGS

The invention will now be described by way of example with reference to the accompanying figures of which:

FIG. 1 is a block diagram of an illustrative embodiment of a security and transcoding model for transfer of content tool portable media device;

FIG. 2 is a block diagram of a second illustrative embodiment of the security and transcoding model for transfer of content to a portable media device; and

FIG. 3 is a block diagram of a portable media device for use in the models of FIGS. 1 and 2.

### DETAILED DESCRIPTION OF THE PREFERRED EMBODIMENTS

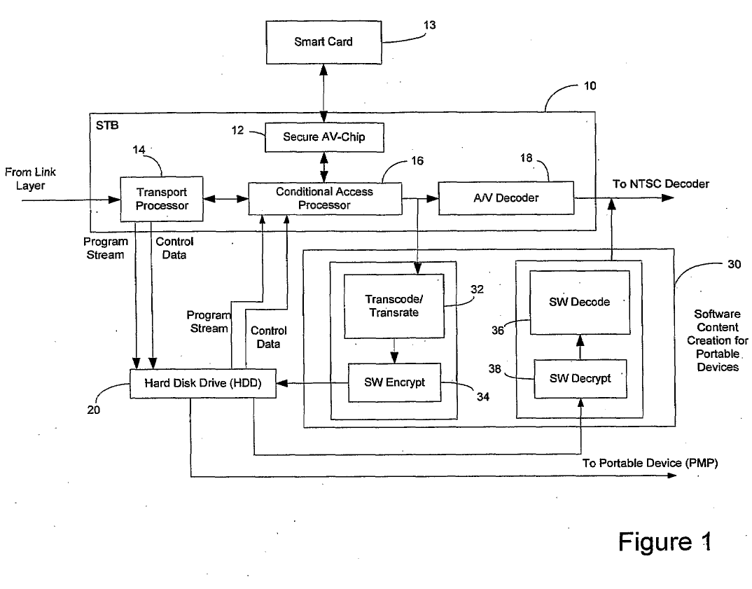

FIG. 1 shows a system for accessing content from a subscription-based broadcast service utilizing a PMP. The system shown here is designed to protect the media content from unauthorized copying and/or further distribution from the PMP. A set-top box (STB) 10 contains a transport processor 14 which receives incoming signals from a link layer of a broadcast system as is well known. The transport processor 14 is operatively connected to a conditional access processor 16 which passes processed signals to an audiovisual decoder 18. The decoded signal is passed from the audiovisual decoder 18 to an NTSC decoder for display by conventional techniques. The conditional access processor 16 is operatively connected to a secure audiovisual chip 12 which may be activated by a smartcard 13 containing unique user or equipment identification coding as is know in the art. A hard disk drive 20 may optionally be provided within the STB 10 or external to the STB 10 as shown. In this embodiment, a program stream and control stream are passed from the transport processor 14 to the hard disk drive 20 where they are stored. Pre-processing software 30 is applied to the stored program stream and control data on the hard disk drive 20. Utilizing the preprocessing software 30, the program stream and control data are encrypted, transcoded and/or transrated to prepare the program stream and control data for output to a PMP.

Content data is placed on the hard disk drive 20 in the broadcast encrypted form, and subsequently decrypted in the conditional access processor 16 for either decoding for display per normal operation or preprocessing for subsequent application such as a transfer to a PMP.

The preprocessing software 30 will now be described in greater detail. To prepare transfer to a PMP, the preprocessing software 30 may apply transcoding/transrating and software encryption. Transcoding is employed to generally change the resolution, compression format, or compression rate. Alternatively transrating is a simpler operation that can also reduce the rate, and therefore file size and image quality. A transcoding operation is generally flexible but demanding on the host processor. The transrating operation is limited to rate reduction at the expense of image quality. The preprocessing software 30 receives input from the conditional access processor 16. Transcoding and/or transrating are applied to the incoming data at 32 followed by a software encryption at 34. The transcoded/transrated encrypted data is then stored on the hard disk drive 20. That data may then be decrypted and decoded at 38, 36 for output to the NTSC decoder and/or may be output to the PMP which contains similar de-encrypting and decoding capabilities in a de-encryption subsystem for de-encrypting the content data for playback on the PMP display.

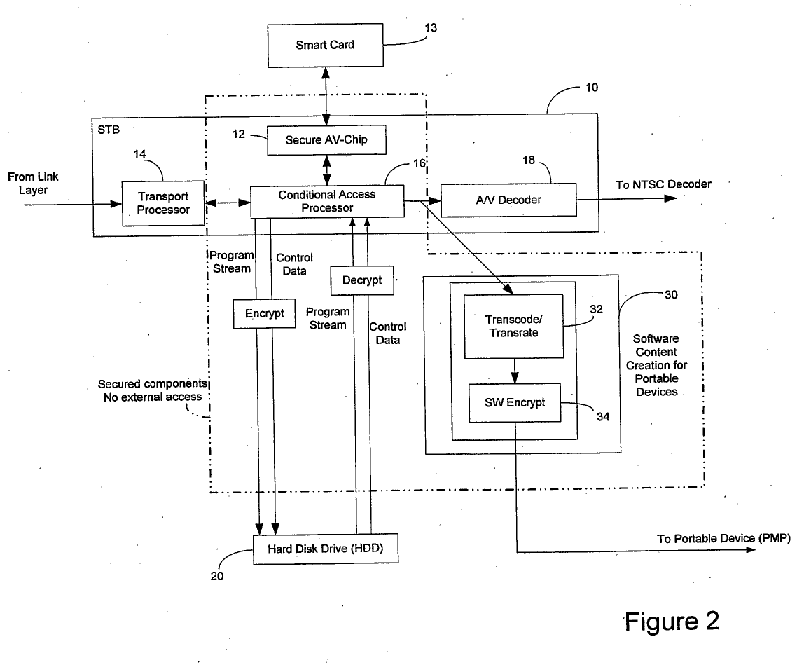

A first alternate embodiment is shown in FIG. 2 wherein content data first passes through the conditional access processor 16 to remove broadcast encryption, is reencrypted with a local encryption mechanism (hardware or software based) and then is stored on the hard disk drive 20. In a subsequent operation, the set-top box 10 pulls the content data from the hard disk drive 20, decrypts it, and then feeds it into the transcode/transrating/software encryption preprocessing software 32, 34 in preparation for transfer to the PMP. In this case, the preprocessing software 30 could be a non-real time operation. Also, the transcoded/transrated/software encrypted information could be stored back in the hard disk drive 20. This allows for off-line non-real time content preparation for transfer to the PMP. In this embodiment, it is desirable to ensure that content that leaves the STB is never in the clear without encryption unless the business rules allow for this case. An example where the entire encryption process may be bypassed is fair-use broadcast content. It should be noted here that the components enclosed in the dotted lines of FIG. 2 are preferable secured components which are enclosed within the set-top box 10 or otherwise enclosed with no external user access.

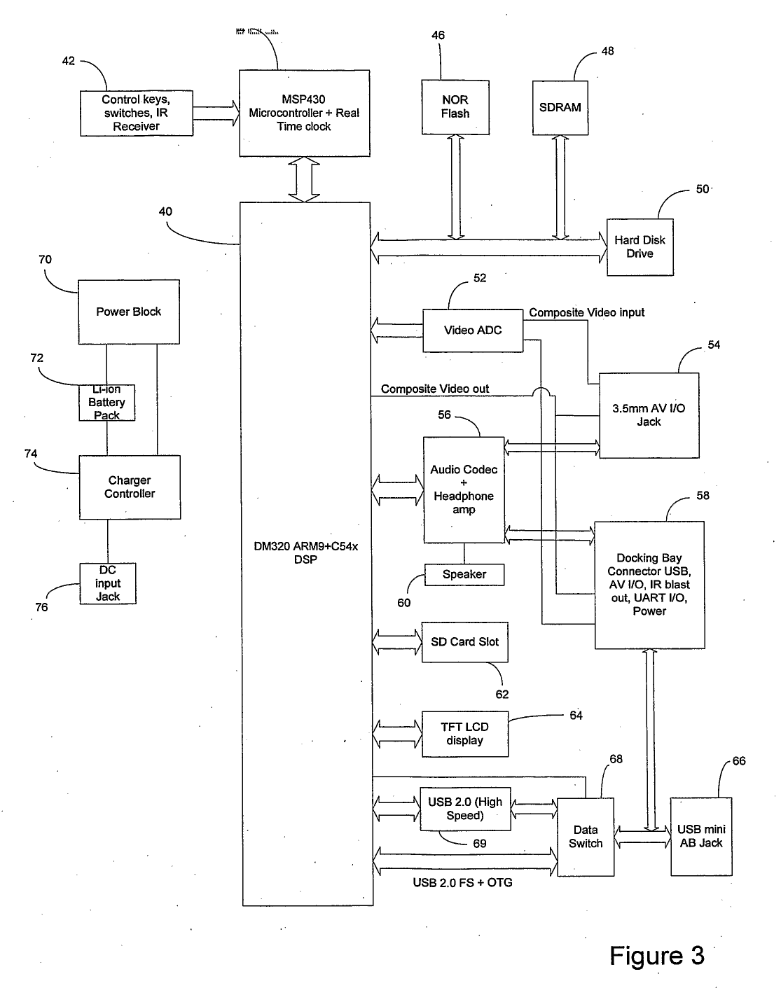

An example of a portable media player is shown in FIG. 3 in block form. It should be understood that while an exemplary portable device, the PMP, is shown here, other portable devices such as personal digital assistants, cellular phones, smart phones etc. capable of receiving the stored content data are within spirit of the invention. A digital signal processor 40 is driven by a microcontroller 44. Controls such as control keys, switches, infrared receivers and other control devices are operatively connected to the microcontroller 44 for allowing user input and control. The device is powered by a power block 70 having a battery 72 and a charger controller 74 operatively connected to the battery 72 and a DC input jack 76. Memory is provided in the form of NOR flash memory 46 and SDRAM 48 being operatively connected to the digital signal processor 40 and a hard disk drive 50. An input output jack 54 or other docking bay connector 58 receives composite video input which is fed through a video ADC 52 to the digital signal processor 40. The composite video output is also fed from the digital signal processor 42 to the input output jack 54 or other docking bay connector 58. This allows for natively compressed analog content to be presented to the PMP. An audio codec and headphone amplifier 56 is connected between a digital signal processor and the connectors 54, 58. A speaker 60 is connected to the headphone amplifier 56. An SD card slot 62 is provided for connecting external memory to the digital signal processor 40. An LCD display 64 is also connected to the digital signal processor 40 as an output device. The PMP also has USB input and output capability through a USB mini jack 66, a data switch 68 and USB interface 69. Transfer of content data from the systems of FIG. 1 or 2 may be provided through either of the connector 58 or the USB jack 66. As discussed earlier, content on the hard disk drive 20 could be transferred transcoded/transrated and/or encrypted in the host before being transferred to the PMP's hard disk drive 50. The PMP includes a de-encryption subsystem having the appropriate mechanisms to decrypt and decode the content for the end user's consumption.

In operation, desired content data, such as a movie, is stored from the set-top box 10 on to the hard disk drive 20. Since the set top box received the data from a subscriber service, it is encrypted before broadcast. The desired content data may be stored on the hard disk drive 20 either before removing broadcast encryption as shown in FIG. 1 or may be stored on the hard disk drive 20 after de-encrypting and applying a local encryption mechanism as shown in FIG. 2. The stored content data could either be transformed (through a set of processes including transcoding or transrating and encryption if necessary) in real-time or off-line as described earlier. The preprocessed content data is then transported to the portable media device shown in FIG. 3. The portable media device has de-encrypting capabilities to restore the content data that has been preprocessed prior to transport.

Advantageously, data may be transferred to a portable device from the subscription service through a set-top box 10 with authorized copy protection provided by the preprocessor 30 and de-encryption on the portable device. It should be understood that while the invention has been described here with reference to exemplary embodiments having portable media players, other portable media devices such as personal digital assistants, cellular phones, smart phones etc. are intended to be within the scope of the invention.

1. A system for passing content data from a subscription service to a portable media device comprising:
a set-top box for receiving the content data from the subscription service;
a data storage device operatively connected with the set-top box; and
a preprocessor being operatively connected to the data storage device and applying encryption to the content data; the preprocessor having an output to the portable media device.

2. The system of claim 1 wherein the preprocessor further applies a transcoding to the encrypted content data.

3. The system of claim 1 wherein the preprocessor further applies a transrating to the encrypted content data.

4. The system of claim 3 wherein the preprocessor operates off-line.

5. A method of passing content data from a set-top box to a portable media device comprising the steps of:
receiving an encrypted data signal from the subscriber service into a set-top box;
storing the encrypted data signal;
de-encrypting the encrypted data signal; and
preprocessing the de-encrypted data signal to apply a software encryption thereto.

6. The method of claim 5 further comprising the step of transcoding the de-encrypted data signal during preprocessing.

7. The method of claim 5 further comprising the step of transrating the de-encrypted data signal touring preprocessing.

8. The method of claim 5 further comprising the step of de-encrypting the data signal within the portable media device.

9. A portable media device for receiving content data from a subscription service comprising:
an input for receiving encrypted content data from a set-top box;
a storage medium for storing the content data; and
a de-encryption subsystem for de-encrypting the content data.
